(19) United States
(12) Patent Application Publication
(10) Pub. No.: US 2005/0268750 A1
(43) Pub. Date: Dec. 8, 2005

(54) Powered surgical screwdriver

(76) Inventors: Robert A. Bruce, Ventura, CA (US); Douglas William Walker, Ventura, CA (US)

Correspondence Address: WILLIAM L. JOHNSON, P. O. BOX 1240, SOMIS, CA, 93066-1240, US

(21) Appl. No.: 11/094,075

(22) Filed: Mar. 30, 2005

Related U.S. Application Data
(60) Provisional application No. 60/558,300, filed on Mar. 30, 2004.

(51) Int. Cl. B25B 21/00

(52) U.S. Cl. 81/52

(57) ABSTRACT

A battery powered, electrically driven screwdriver has an elongated body with a narrow forward portion disposed toward the working end, and a relatively larger rearward portion disposed distal from the working end. A tapering transition connects the narrow forward portion with the larger rearward portion. At least one fingertip- operable switch is mounted on the forward portion. The at least one fingertip switch is disposed at a position consistent with a pad of a human index finger when the screwdriver is held in a “pencil” style of grip. One embodiment includes a drive system capable of applying limited torque to said surgical screws, wherein said torque is limited at or below said predetermined, known maximum torsion capability of specific surgical screws.

This application claims priority of U.S. provisional application No. 60/558,300 filed on 30 Mar. 2004.

### BACKGROUND OF THE INVENTION

1. Field of the Invention

This invention relates to surgical instruments generally and more specifically to electrically powered, handheld rotary screwdrivers for surgical use.

2. Description of the Related Art

Power assisted tools, including screwdrivers, are commonly employed by orthopedic surgeons in the surgical environment. The design of such tools has commonly been dominated by convention or historical context of power tools, with the result that many of the surgeons tools resemble those of the carpenter or woodworker. In many procedures such designs are perfectly adequate; however, more precise and delicate procedures are facilitated by more specialized tool designs.

Electrically powered screwdrivers powered by batteries are available for various purposes, but tend to follow two basic design groups: a first, familiar design is the basic cylindrical powered driver, with the batteries inserted into the cylindrical handle in the manner of a traditional flashlight, axially end-to-end; the second common design is the Pistol grip design, with a main body and a transverse, pistol-type grip (sometimes activated by a trigger switch, completing the “pistol” metaphor). Designs in the first category are not easy to manipulate with delicacy, being gripped in the clenched fist like a dagger. Those in the second group are also unwieldy and not easy to use in restricted spaces. Neither design is optimized for fine surgical applications.

Prior screwdriver designs have generally been intended to apply as much torque as possible, without consideration of the torsional failure point of the screws upon which the driver will operate. This has not previously been seen as a serious problem in need of remedy.

The need persists for an improved powered screwdriver for surgical applications.

### SUMMARY OF THE INVENTION

In view of the above problems, the present invention in one aspect is a battery powered, electrically driven screwdriver having an elongated body with a narrow forward portion disposed toward the working end, and a relatively larger rearward portion disposed distal from the working end. A tapering transition connects the narrow forward portion with the larger rearward portion. At least one fingertip-operable switch is mounted on the forward portion. The at least one fingertip switch is disposed at a position consistent with a pad of a human index finger when the screwdriver is held in a “pencil” style of grip.

In some embodiments, the screwdriver is substantially sealed against intrusion of fluids or debris (during surgical use). In some embodiments the screwdriver is adapted to be disposable after surgical use, to discourage infection.

In another aspect, the invention is an electrically driven, hand held screwdriver that includes a drive system adapted to apply limited torque to surgical screws, wherein said torque is limited at or below a predetermined, known maximum torsion capability of specific surgical screws.

These and other features and advantages of the invention will be apparent to those skilled in the art from the following detailed description of preferred embodiments, taken together with the accompanying drawings, in which:

### BRIEF DESCRIPTION OF THE DRAWINGS

FIG. 1 is a perspective view of a powered surgical screwdriver in accordance with the invention;

FIG. 2 is a side view of the powered surgical screwdriver of FIG. 1;

FIG. 3 is a plan view from above (top view) of the screwdriver of FIGS. 1 and 2;

FIG. 4 is a frontal end view of the screwdriver of FIGS. 1-3;

FIG. 5 is a end view from the rear of the screwdriver of FIGS. 1-4;

FIG. 6 is a plan view from below of the screwdriver of FIGS. 1-5; and

FIG. 7 is a partially exploded view of the screwdriver of FIGS. 1-6, with internal details exposed to view.

### DETAILED DESCRIPTION OF THE INVENTION

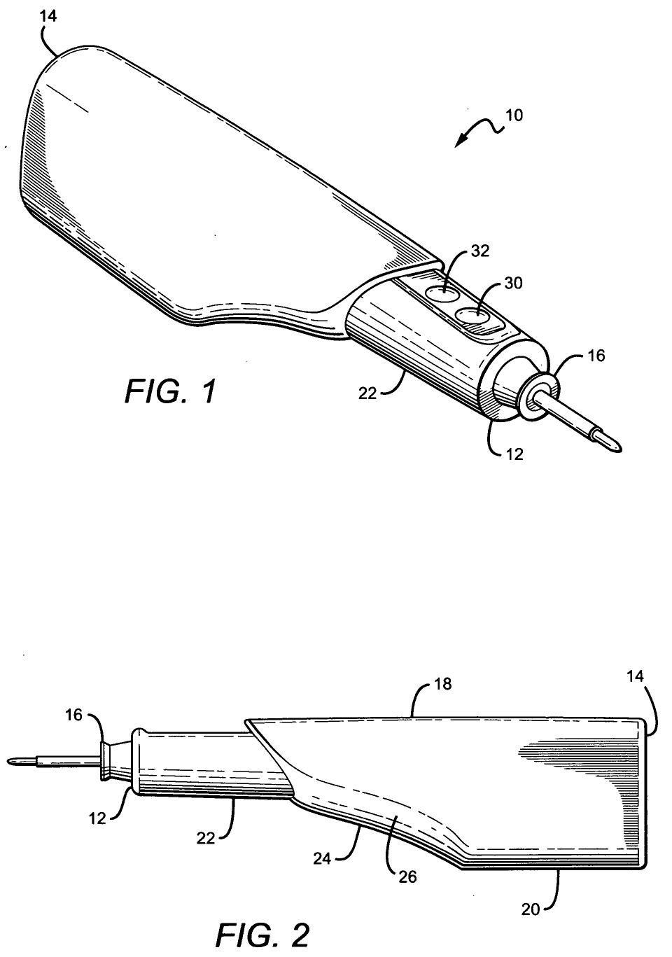

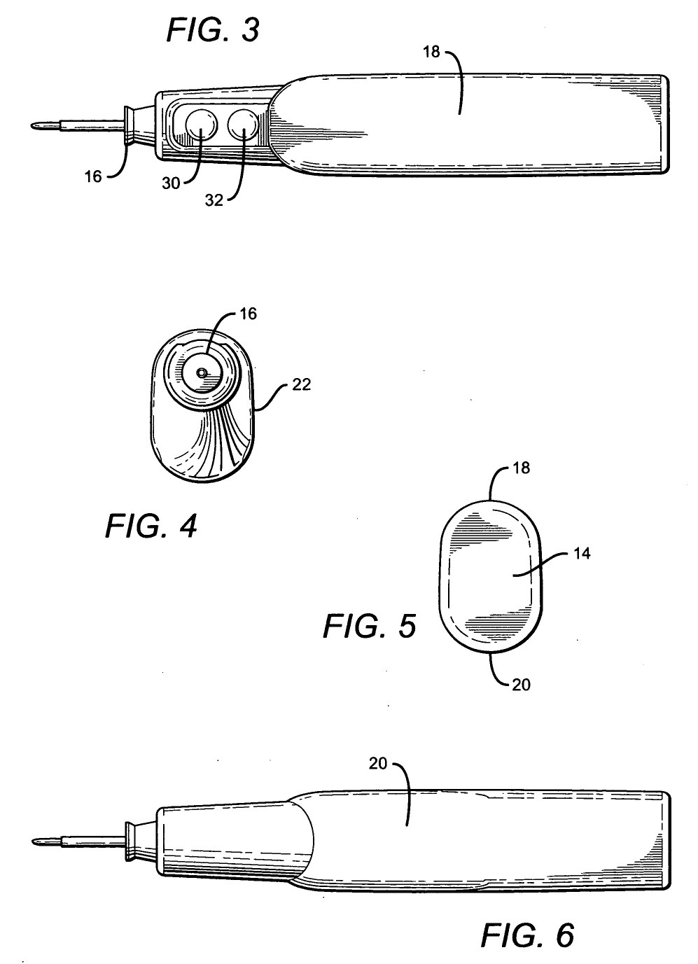

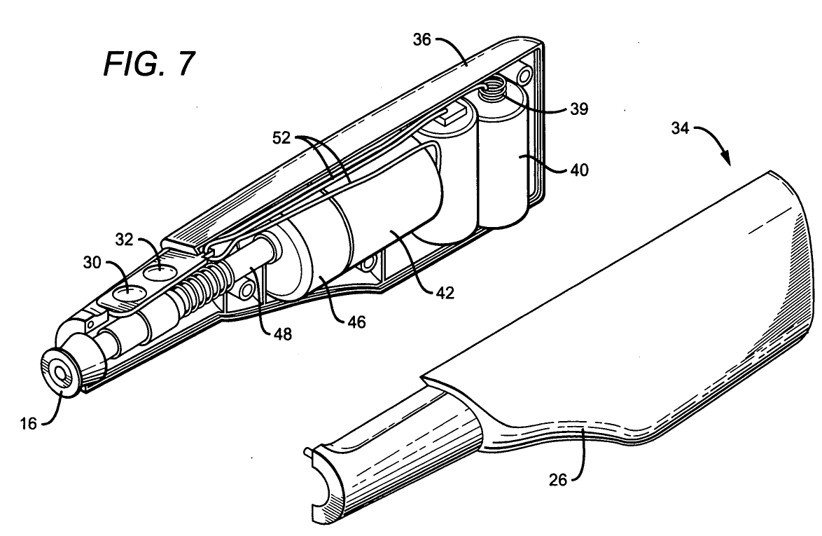

FIGS. 1 through 6 show external views of a typical embodiment of an electrically powered, low torque, surgical screwdriver in accordance with the invention. FIG. 7 shows an exploded view exposing internal details.

As seen in FIG. 1, the screwdriver has a contoured, elongated body 10 with a forward (“drive”) end 12 and a rearward end 14 that differ from one another in thickness and shape. As the end view FIG. 5 shows, the thicker, rearward end 14 has increased bulk and volume which is sufficient to accommodate batteries and an electric motor; the narrow, forward end 12 has decreased cross section to allow fine manipulation within confined spaces, as well as to facilitate manual grip between the thumb and index finger (or a combination of index and second fingers) in a “pencil” style of grip. Either a fixed drive blade or a collet 16 is provided at the forward end 12 to engage and drive surgical screws. Preferably, a collet 16 is provided that can accept a variety of different, interchangeable drive blades of different sizes and configurations.

Preferably, the body is not generally cylindrical. As seen in the end view, the body preferably presents not a round but a more oval end view or cross section, with a longer dimension between top 18 and bottom 20 than from side to side. This shape is preferred to a cylinder, for reasons discussed later.

The screwdriver body 10 is preferably tapered as shown in the figures, from a wider rearward end 14 to the relatively more narrow forward neck 22, terminating in forward end 12. The transition from wider to more narrow is preferably accomplished by tapering curve 24 disposed primarily along the lower forward portion of the body. By contrast, the top side 18 preferably follows a more generally linear path. The sweeping curve of taper 24 complements and comfortably engages the muscle between a human thumb and index finger (adductor pollicis muscle). A beveled shoulder 26 is preferably disposed along or near the taper 24 to provide a tactile index of position and to enhance positive grip.

Forward and reverse polarity control switches (30 and 32, respectively) are disposed on the top of the forward neck 22, specifically positioned to be comfortably accessible to the tip or end pad of a user's index finger when the screwdriver is held in a natural, pencil style grip. These control switches allow the user to select “forward” or “reverse” turn directions, and are preferably sealed, push-button switches disposed in close proximity to one another. Specifically, the distance between the forward and reverse controls is chosen such that the index finger of an average human hand may move between said controls easily by flexing the index finger. Significantly, the index finger can move between the controls without changing the hand's grip on the screwdriver.

In a preferred embodiment, switches 30 and 32 are sealed by a membrane to prevent blood or other contaminants from entering into the internal mechanism of the powered screwdriver.

The drawings also show the internal workings of one embodiment of the driver, including battery clips 39, batteries 40 and a D.C. electric motor 42. Batteries 40, preferably transversely mounted as shown, provide drive voltage to the D.C. motor. A polarity control circuit controlled by forward/reverse control switches 30 and 32 allows on/off and polarity reversal controls of the motor. (As discussed above, control switches are mounted on the forward neck of the driver). D.C. motor 42 preferably drives an offset drive transmission system 46, which transmits torque to a drive shaft 48. (In the particular embodiment shown in FIG. 7 the transmission and motor are housed together in a unitary mechanism, as shown and as discussed below). The drive shaft 48 is preferably coupled to the quick release collet 16 at the front of the driver, to facilitate quick interchange of drive tools. The driver is thus not limited (in general) to a particular screw system such as Phillips, Allen head, star socket or flat blade, but can accept a variety of interchangeable blades. Particular embodiments may be limited to specific blades, for reasons discussed below in connection with limited torque embodiments.

The overall structure of the screwdriver body is preferably not symmetrical about the rotatable axis of the actual screw drive shaft 48, but rather the axis of drive shaft 48 is offset from the center axis of the wider, rearward portion of the screwdriver body. Internal and external features of the screwdriver are designed to encourage this offset geometry while efficiently utilizing the available volume. Battery clips 39 are preferably included, capable of receiving cylindrical batteries,in an orientation transverse to the axis of the driver body. For example, in the embodiment shown the batteries are mounted with their axes transverse to the screw drive axis; not, as in most powered drivers, generally in line with said axis. This arrangement reduces overall length and uses internal volume efficently, while keeping the balance point close to the support point.

The drive motor 42 is preferably coupled to the screw drive shaft 48 via an offset gear train 46 or similar transmission mechanism. Because the rotatable drive shaft 48 is offset with respect to the center of the body, the hand is able to exert more torque (or resist more torque) by exerting a given force. The torque exerted is increased by increasing the distance from the shaft to the point of application of force. The offset drive tends to increase such distance, the force being exerted on the handle body on the edge further removed from the shaft.

The screwdriver of the invention is adapted to be gripped in the manner most commonly employed for gripping pencils or other writing implements (“pencil grip”). As such, the dimensions, proportion and design of the screwdriver are all relevant in their relation to the usual dimensions, proportion and design of the human hand. Specifically, it is well adapted to be held in a position substantially in the traditional “pencil grip”. With the index finger positioned at the switches 30 and 32, the balance point of the screwdriver is preferably disposed substantially over the fleshy, webbed structure between the thumb and the first (index) finger, resting substantially on the adductor pollicis muscle, with rotating drive point forward in the position corresponding to that of the pencil or pen point. The forward, narrow portion of the screwdriver rests against and is controlled by the thumb, index; and middle fingers; the index finger can reach the forward control and reverse control button which are forwardly positioned on top of the narrow, forward neck of the screwdriver, while the middle finger supports the neck from the side. The forward and reverse control switches 30 and 32 are disposed within the reach of a comfortably flexed, average index finger. Furthermore, the distance between the forward and reverse controls is chosen such that the index finger may move between said controls easily, primarily by flexing the index finger.

In addition to the positions of the controls, other preferred specific features facilitate the use of the pencil grip. The surfaces of the screwdriver are generally rounded and curved, which has been found to enhance comfortable grip. Optionally, a gnurled or textured surface can be employed over some or all of the surface to further facilitate grip. As shown in end view (FIG. 5), the cross section of at least the rearward body portion of the screwdriver is generally oval (but not necessarily perfectly elliptical or symmetrical), having a wider dimension in one direction than the other. For example, it can suitably be elliptical, having unequal major and minor axes. It is not required to be perfectly symmetrical. The generally oval form is advantageous in that it allows the hand to apply or resist torque more effectively, utilizing the longer dimension for more torque, without necessarily adding excess volume (as would a cylindrical object of the same larger diameter). The irregularity of the oval form is also more easily gripped than a cylindrical or regular form.

The Center of Gravity of the device, including batteries, is preferably just over or slightly rearward of support point. The support point is defined by the typical position of the adductor pollicis muscle, and given that the index finger pad is positioned to touch both of the forward and reverse controls (30 and 32) on the forward neck portion of the driver. In one embodiment, the distance to the support point is found to be in the range of 4 to 8 centimeters rearward from the rearmost control switch (30 or 32).

The overall shape of the screwdriver of the invention is preferably not encumbered by the addition of any prominent transverse projection such as a “pistol” grip. Pistol grips are known for promoting higher torque powered tools, but the prominent projection of such a grip would be more likely to cause interference in a delicate surgical position. Furthermore, the pistol grip does not promote delicate or fine control of the driver.

Some variation from proportions described is permissible subject to the constraints set forth herein regarding the pencil grip, control of the forward/reverse switches, balance point, and dimensions of a human index finger.

Other features of the invention make it well adapted for surgical use. Due to the non-cylindrical, oval shape of the body, the screwdriver of the invention is not likely to roll freely when placed on an inclined plane. This reduces the chances of dropping or losing the instrument during a surgical procedure. Surgical tools are required to be sterile during each use; this implies that they must either be a) capable of enduring autoclave temperatures, or b) disposable, to prevent re-use. The screwdriver of the invention is intended to be disposable (except for recycling of some components). Accordingly, the exterior casing of the body is assembled by snapping And preferably without use of any screws. One practical method of construction is shown in the partially exploded FIG. 7, which also reveals one internal arrangement of components. Removable screws could encourage a user to replace batteries and thereafter re-use the driver in a manner which is inconsistent with proper surgical sterility procedures. The casing is preferably sealed after assembly, for example by an adhesive, to prevent entry of blood, fluids, or other adulterants into the interior mechanism.

In one embodiment, the torque capabilities of the screwdriver's D.C. motor are preferably intentionally limited to a pre-determined maximum torque capability so that the screwdriver will, with adequate battery power, provide up to a predetermined torque limit before stalling, but will halt if a greater torque is applied. This characteristic is desirable because it makes it less likely that a surgical screw can be snapped. For typical applications, for example, surgical screws are commonly used having a shaft diameter of 1.7 millimeter, 4 to 5 mm length, made from titanium alloy (suitably Ti 6Aluminum/4Vanadium) and having a self tapping thread for bone. These and other surgical screws are available from Kinamed, Inc. in Camarillo, Cal. The inventors have discovered that such screws can fail by fracture (snap) if excess torque is applied. Accordingly, in one embodiment the motor is chosen or modified so that it is incapable of exerting torque in excess of a threshold torque. For example, in a specific embodiment the driver stalls in the neighborhood of 78 inch-ounces. More generally, it is possible to specifically design the driver for a desired threshold torque, for example by using current or voltage limiting D.C. drive circuits. A variety of current or voltage limiting circuits are known in the art of power supply or motor controls which could be employed for this purpose. Accordingly, in one embodiment the screwdriver of the invention is specifically limited in that it is incapable of exerting torque in excess of a given threshold torque, the threshold torque being a design parameter of the driver and predetermined to be less than the torque which will likely snap a specific surgical screw. It is noteworthy in this respect that the driver is designed for unusual, surgical screws having unusual strength characteristics. Furthermore, it is very important in surgical applications that the screws not be damaged during placement. Thus, this torque limitation is more than usually important for the surgical power driver, as compared to other drivers.

In the controlled torque embodiment of the invention, the torque characteristics of the motor is a design parameter dictated by the intended application. It should be understood that the “threshold torque” as used herein is determined by the specific intended application, and does not merely refer to an arbitrary, inherent motor characteristic, except to the extent that a particular motor characteristic is intentionally chosen in accordance with the desired application.

Accordingly, one embodiment of the invention employs a Model HG650B-052 DC gearmotor from Hennkwell Ind. Co., Ltd. Electrical, physical and performance characteristics are shown in the attached drawings. The characteristics of this motor have been found particularly suitable for the surgical screw driver of the invention. The motors are driven by battery power in the invention (thus the torque curves labeled “battery” apply).

The invention also includes methods as performed by the apparatus described, including methods for limiting the torque applied to surgical screws during insertion, and other such procedures facilitated or performed with the powered screwdriver described herein.

In another aspect, the invention includes a matched system of surgical screws and disposable surgical screwdriver, wherein the disposable screwdriver is designed to have a predetermined threshold of torque before stalling, and the surgical screws matched to the disposable driver are selected to be capable of withstanding at least the predetermined threshold of torque without failure. Both screws and screwdriver of the system are preferably pre-packaged, ready for use, sterilized in a sealed package to be opened only in the sterile surgical environment. Preferably the screws and driver should be packaged in a combination packaging system, but alternatively could be clearly identified by a code or marking system.

Details of the forward and reverse polarity switches, D.C., motor, Battery and drive circuits are not shown, as these systems can easily be designed for a particular application by one with skill in the electrical arts, given the important limitations described above. One with skill in the electrical arts will easily understand how forward and reverse directions of a D.C. motor can be controlled by reversing polarity of the current flow, and how to accommodate on/off control of such a simple motor circuit. Batteries having known and stable characteristics should be included in a pre-sealed embodiment of the screwdriver, so that the battery characteristics can be included in the design process as a known and predictable parameter. A sealed plastic housing without removable screws will discourage removal or replacement of the batteries by the user.

A further noteworthy aspect of the screwdriver of the invention is that its body is free from any substantial transverse projections or handle, so that said body cannot be gripped in a pistol style of grip. This encourages the intended grip, which in turn facilitates better fine control over the tip during surgery.

While several illustrative embodiments of the invention have been shown and described, numerous variations and alternate embodiments will occur to those skilled in the art. Such variations and alternate embodiments are contemplated, and can be made without departing from the spirit and scope of the invention as defined in the appended claims.

As used herein and in the claims the words “comprising,” “having,” and “including” should be understood as open ended and not limiting, to convey the meaning: “including but not limited to”.

1. A battery powered, electrically driven screwdriver, including a battery compartment and an electric motor coupled to a drive system, said screwdriver suitable for surgical use, comprising:
elongated body having a narrow forward portion disposed toward the working end, and a relatively larger rearward portion disposed distal from the working end;
a tapering transition connecting said narrow forward portion with said larger rearward portion;
at least one fingertip-operable switch mounted on the forward portion;
wherein said at least one fingertip switch is disposed at a position consistent with a pad of a human index finger when the screwdriver is held in a “pencil” style of grip.

2. The screwdriver of claim 1, wherein said rearward portion has a height dimension that is greater than a thickness dimension of said rearward portion.

3. The screwdriver of claim 2, wherein said rearward portion is substantially oval in section.

4. The screwdriver of claim 2, wherein said narrow forward portion is adapted to be gripped between the thumb and index finger of a human hand, and wherein said at least one switch is disposed on top of the narrow forward portion, allowing a pencil style grip with the narrow forward portion interposed between the thumb and index finger in opposition.

5. The screwdriver of claim 4 wherein said tapering transition is dimensioned to rest on the fleshy valley between thumb and index finger when the screwdriver is held in a pencil style grip.

6. The screwdriver of claim 1, wherein said at least one fingertip-operable switch comprises at least two fingertip-operable switches, coupled to activate forward and reverse drive directions of the electric motor.

7. The screwdriver of claim 6, wherein said at least two fingertip-operable switches are mounted in proximity to one another, with separation no greater than the distance easily spanned by adjusting an index finger by flexing its joints without changing the grip of any other fingers or thumb on the screwdriver body.

8. The screwdriver of claim 7 wherein said separation is less than or equal to 2 inches.

9. The screwdriver of claim 1, wherein said driver has a drive axis offset in relation to the center axis of said rearward portion.

10. The screwdriver of claim 9 wherein said drive axis is generally coaxial with the axis of the narrow forward portion.

11. The screwdriver of claim 1 wherein said tapering transition is recurved.

12. The screwdriver of claim 1, further comprising a releasable collet, for receiving interchangeable driver attachments.

13. The screwdriver of claim 1, wherein said elongated body is substantially sealed against intrusion of fluids or debris.

14. The screwdriver of claim 13, wherein said elongated body is permanently sealed to prevent replacement of the batteries, said screwdriver being intended for disposal after surgical use.

15. The screwdriver of claim 1, wherein said body is free from substantial transverse projections or handle, so that said body cannot be gripped in a pistol style of grip.

16. A battery powered, electrically driven screwdriver, including a battery compartment and a drive system including an electric motor, said screwdriver suitable for surgical use, comprising:
an elongated body, adapted to be gripped in a “pencil” grip by a human hand;
wherein the drive system is adapted to limit available torque to below a predetermined maximum torque;
said predetermined maximum torque being chosen as a value below the torsional failure limit for a pre-selected surgical screw.

17. The screwdriver of claim 16 wherein said drive system limits available torque by stalling at a torque below said predetermined maximum torque.

18. A screwdriver-screw system suitable for surgical uses, comprising:
a) surgical screws having a predetermined head pattern and a predetermined, known maximum torsion capability before failure; and
b) A battery powered, electrically driven screwdriver, comprising:
an elongated body, adapted to be gripped in a “pencil” grip by a human hand;
a drive system capable of applying limited torque to said surgical screws, wherein said torque is limited at or below said predetermined, known maximum torsion capability of said surgical screws.

19. The system of claim 18, wherein said screwdriver and said screws are identified by packaging or markings that identify the screwdriver and screws specifically adapted for use in a specific combination, based upon their predetermined torque characteristics.

20. The system of claim last 18, further comprising one or more driver bits having a predetermined drive pattern that engages with said predetermined head pattern of said screws, and wherein said predetermined head and drive patterns are selected to identify the known maximum torsion capability of said screws.

21. The system of claim 18, wherein said screwdriver, and said screws are packaged in a sterile state in one or more sealed packages adapted to maintain sterility of the system, suitable to be opened in the surgical environment immediately before use.

22. The system of claim 18 wherein said screws comprise Titanium.
